(19) United States
(12) Patent Application Publication
(10) Pub. No.: US 2005/0003061 A1
(43) Pub. Date: Jan. 6, 2005

(54) Process for the production of plant ingredients

(75) Inventors: Catherine Fryirs, Enfield (AU); Ray Neale, Enfield (AU); Sarbjeet Kaur, Enfield (AU)

Correspondence Address: SUGHRUE MION, PLLC, 2100 PENNSYLVANIA AVENUE, N.W., SUITE 800, WASHINGTON, DC, 20037, US

(73) Assignee: GEORGE WESTON FOODS LIMITED

(21) Appl. No.: 10/609,498

(22) Filed: Jul. 1, 2003

(51) Int. Cl. A23L 1/10

(52) U.S. Cl. 426/430

(57) ABSTRACT

Process for the production of lupin protein extracts, food products, containing lupin protein extracts and lupin protein extracts so produced are described. The process of the invention comprises a process for the production of lupin protein extracts from lupins, comprising: (a) extracting lupin meal or flour with water at alkaline pH; (b) separating an alkali soluble lupin protein containing component from an alkali insoluble fibrous component; (c) adjusting the pH of the protein component with acid to a pH between 3-5.0, and thereafter separating a food grade lupin protein extract (PF1) from an acid soluble lupin protein containing component; and optionally,
(d) reacting the acid soluble lupin protein containing component with a C₁-C₆ food grade organic solvent and recovering therefrom a second food grade lupin protein extract (PF3); or
(e) raising the pH of the acid soluble lupin protein component to pH 5-7, and optionally recovering a lupin protein isolate, followed by the addition of a C₁-C₆ food grade organic solvent and recovering therefrom a third food grade lupin protein fraction (PF2).

### FIELD OF THE INVENTION

This invention relates to processes for the production of food grade lupin proteins, particularly lupin protein extracts, and use of lupin protein in foods and other applications. Lupin fibre may also be prepared in accordance with the invention, and products obtained therefrom.

### BACKGROUND OF THE INVENTION

Lupins are members of the pea family and their composition comprises proteins, fibre, oil and carbohydrate. The proteins and fibre components of lupin possess properties that make them potentially useful as food additives and stock feed ingredients. However, these components have had limited use in the past due to problems with intense colouration and off flavours which adversely affected the foods to which they were added.

A number of processes for lupin extraction have been proposed but they generally fail to meet the flavour and colour profiles required for extracted plant components. Such processes may also be cumbersome to implement, and generally inefficient. For example, Australian Patent Application AU 199676195 describes an extraction process for lupins where a water slurry of lupin meal or flour is first subjected to acid extraction, then an alkaline second extraction, and finally to a countercurrent washing method to produce both a fibre fortified plant product and a protein milk product. This process uses large amounts of water, creates large amounts of salt water waste, and no benefits of colour improvement or flavour profile are described.

U.S. Pat. No. 6,335,044 B1, describes a method for treating and processing lupin seeds by means of crushing and shaping the seeds into platelet-shaped flakes, heating and de-oiling the flakes, followed by disembitterment using an aqueous process. Again colour problems are not addressed. Questions concerning the microbiological stability of such products also arise. Functionality of the extracted protein may also be affected.

The major component of the carbohydrates present in lupins is galactose. No previous processes of lupin extraction has provided for lupin fibre recovery, and subsequent use, for example the extraction of pectin type hydrocolloids and/or galactose and recovery of galactose.

### SUMMARY OF THE INVENTION

In its broadest aspect, this invention is concerned with the processing of lupins, such as lupin flour or meal to produce lupin protein and optionally lupin fibre having high functionality and possessing a light colour, a bland non-bitter taste and low microbiological load, which may, for example, be referred to as food grade lupin protein. The novel process in accordance with an aspect of this invention also shows improvements in yield and water usage over other described extraction methods. The process is also simple to implement, and avoids excess water consumption and countercurrent washing or ultra filtration steps to increase purity, in contrast to prior art approaches.

The lupin protein extracts derived from the process can be used in a range of food and other applications, a number of which are described hereafter.

In accordance with a first aspect of this invention there is provided a process for the production of lupin protein extracts from lupins, comprising:
(a) extracting lupin meal or flour with water at alkaline pH;
(b) separating an alkali soluble lupin protein containing component from an alkali insoluble fibrous component;
(c) adjusting the pH of the protein component with acid to a pH between 3-5.0, and thereafter separating a food grade lupin protein exract (PF1) from an acid soluble lupin protein containing component; and optionally,
(d) reacting the acid soluble lupin protein containing component with a C₁-C₆ food grade organic solvent and recovering therefrom a second food grade lupin protein extract (PF3); or
(e) raising the pH of the acid soluble lupin protein component to pH 5-7 and optionally recovering a lupin protein isolate, followed by the addition of a C₁-C₆ food grade organic solvent and recovering therefrom a third food grade lupin protein extract (PF2).

Lupin protein extract PF1 and lupin protein extract PF2 or PF3 are preferably recovered by the process in accordance with this aspect of the invention. These lupin protein extracts may be combined for subsequent use, or used individually in a variety of applications as hereinafter described. Preferably the lupin protein isolate is also recovered.

In another aspect this invention relates to lupin protein produced according to a process in accordance with the process aspect of this invention. Preferably the lupin protein is selected from one or more of lupin protein extract PF1, PF2 and/or PF3.

In another aspect of this invention there is provided a food product containing a food grade lupin protein, for example as a replacement for dairy, egg, soy or meat protein. Preferably the lupin protein is selected from one or more of lupin protein extracts PF1, PF2 and/or PF3. Preferred applications include as dairy replacers in powders (eg non dairy coffee whitener or creamer), in hot and/or cold beverages and/or food ingredients for soups, sauces, pastas, ice creams and other dairy/food products, and as an egg white replacer in applications such as desserts, fish, meat and bakery products.

In another aspect of this invention there is provided a nutritional supplement containing a food grade lupin protein. Preferably the food grade lupin protein is selected from lupin protein extracts PF1, PF2 and/or PF3.

In another aspect of this invention there is provided a paper coating composition containing a lupin protein. Preferably the lupin protein is one or more of lupin protein extracts PF1, PF2 and/or PF3.

In another aspect of this invention there is provided a feed ingredient containing a lupin protein fraction for aquaculture and animal feed. Preferably the lupin protein is one or more of lupin extracts PF1, PF2 and/or PF3.

The fibrous component produced in accordance with the process embodiment of this invention is preferably recovered according to a further embodiment of this invention. The fibrous component may be treated with peroxide or washed in organic solvent to produce an off-white fibre. This fibre may be used as a unique source of fibre or processed to produce pectin like hydrocolloids or even further processed with enzymes such as galactosidases to recover the galactose.

### DESCRIPTION OF THE PREFERRED EMBODIMENTS

Surprisingly, it has been found that protein and optionally fibre can be extracted from lupins, particularly lupin flour and/or meal, with colour and flavour removed while retaining functional properties of the protein and fibre. In addition, the process gives high yield and minimal waste, low microbiological load, and high purity.

In its broadest aspect, this invention is concerned with the processing of lupins, such as lupin flour or meal to produce lupin protein and optionally lupin fibre having high functionality and possessing a light colour, a bland non-bitter taste and low microbiological load, which may, for example, be referred to as food grade lupin protein.

In accordance with a first aspect of this invention there is provided a process for the production of lupin protein from lupins, comprising:
(a) extracting lupin meal or flour with water at alkaline pH;
(f) separating an alkali soluble lupin protein containing component from an alkali insoluble fibrous component;
(g) adjusting the pH of the protein component with acid to a pH between 3-5.0, and thereafter separating a food grade lupin protein extract (PF1) from an acid soluble lupin protein containing component; and optionally,
(d) reacting the acid soluble lupin protein containing component with a C₁-C₆ food grade organic solvent and recovering therefrom a second food grade lupin protein fraction (PF3); or (e) raising the pH of the acid soluble lupin protein component to pH 5.5-8, followed by the addition of a C₁-C₆ food grade organic solvent and recovering therefrom a third food grade lupin protein extract (PF2).

Lupin protein extracts may also be referred to as lupin protein fractions or lupin protein. The extracts are generally mixtures of lupin protein having particularly advantageous properties as herein described. The extracts may also contain some fats and carbohydrates as hereafter described.

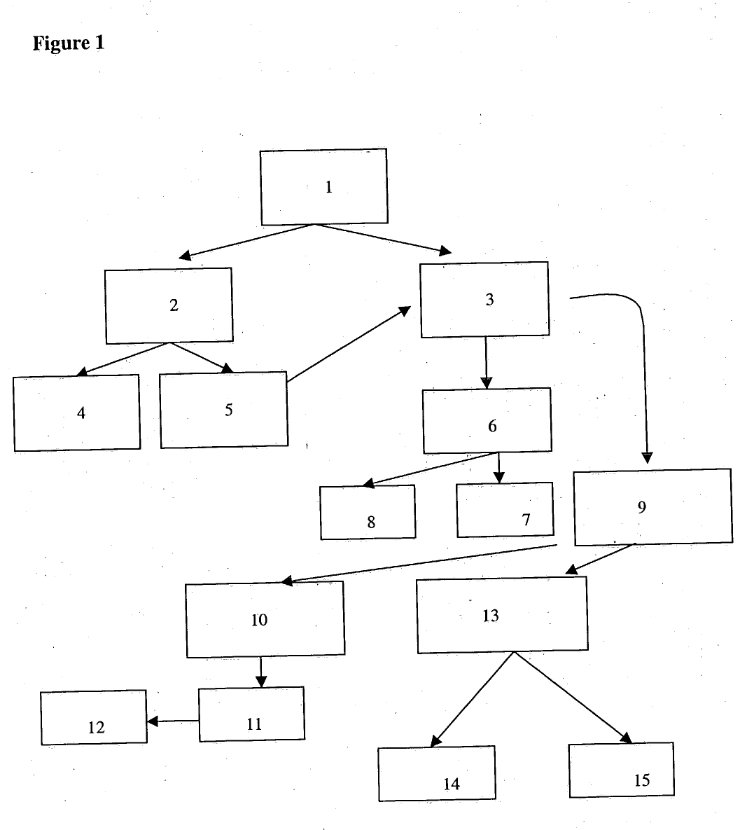

A detailed schematic diagram of the process embodiment of this invention is shown in FIG. 1 with reference numbers for each step in the process included for ease of description.

Lupin flour and/or meal may be prepared by standard procedures, such as crushing or comminuting and/or grinding or milling lupin plants and/or seeds, which may, or may not be, dehulled. By way of example only, a flour having particle sizes from about 50 to about 800 micrometres may be prepared. Lupin meal may be prepared by crushing the lupin plants and/or seeds, but not comminuting the same. Lupin plant and/or seed may be heat treated, for example by steam treatment or other thermal treatment such as contact with heated surfaces, radiant or microwave heat application or the like, prior to conversion to flour and/or meal. The lupin flour/meal may or may not be treated with an organic solvent such as hexane remove oil prior to further processing.

Lupin flour/meal, which may or may not have been heat treated, may be mixed with water and adjusted using any food grade alkali system, such as sodium hydroxide, calcium hydroxide, potassium hydroxide or sodium carbonate to an alkali pH (that is above 7), and preferably between 8.0 and 9.0. Alternatively, water may first be pH adjusted with an alkali system and then added to the lupin flour/meal. The extent and duration of mixing or contact with the alkali conditions are not critical to the invention. Extraction conditions may vary according to the amount of material being extracted, the nature of lupin flour/meal, temperature and vigour of mixing. By way of example, sufficient water may be added to the flour/meal to form a slurry or paste. A mixture of 1 part flour to 2-10 parts water, preferably 4-8 parts water, may advantageously be used. The use of small volumes of water minimises waste production, conserves water usage, and overall increases the production efficiency of the process. After pH adjustment the extraction may be carried out, for example, by gentle mixing at ambient temperature. The time period of the extraction is that which extracts lupin protein from lupin fibre. For example, this may be from 15 minutes to 5 hours at ambient temperature (about 20° C.). Shorter time periods may be used at higher process temperatures, for example at 25° C., or longer time periods at lower temperatures.

The resultant alkali water extract (1) may be centrifuged or otherwise separated to produce a fibre pellet (2) and a supernatant (3). The fibre pellet (2) may be used directly as a plant fibre, or processed in a range of applications as described hereafter. Alternatively, the pellet (2) may be diluted with water and centrifuged to give a purer fibre pellet (4) and another supernatant (5), which may be added to the first supernatant (3). These combined supernatants can then be dried to give lupin protein having a wide range of uses, including use in animal/aquafeed.

The fibrous pellet (2 or 4) contains pectin-like hydrocolloids. This pellet may be treated with one or more enzymes such as galactosidases to yield galactose. Galactose so produced may be used in food products, drinks and in other applications. Pectins and other carbohydrate components may also be recovered.

The pH of the protein supernatant (3), or (3) and (5), is then adjusted to between about 3.0 and about 5.0 using any food acid including hydrochloric acid, sulphuric acid or phosphoric acid. This pH range, more preferably between 3.5 and 4.5, gives rise to a lupin protein precipitate which may be collected, for example, by centrifugation to give a lupin protein precipitate (6), designated protein extract or fraction 1 (PF1), and a third protein supernatant (9). The pH of PF1 may be adjusted to between pH 5 and 7, preferably between 5.5 and 6.5, to improve desired functional properties. It may then be washed with ethanol or other solvent if desired, and centrifuged to remove colour and flavour, and reduce microbiological load (7).

Lupin protein fraction PF1 may be modified using physical, chemical and/or enzymatic means as are well known in the art, and may be dried by any commercial means including freeze-drying or spay drying.

The third supernatant (9) is then brought to the pH level ranging from 5-7, preferably at 5.7 to 6.3 with any food grade alkali including sodium hydroxide, calcium hydroxide, potassium hydroxide, or sodium carbonate. Calcium hydroxide is preferred. This pH treated supernatant (9) containing finely precipitated lupin protein may be centrifuged to obtain an additional protein isolate (10) and a fourth supernatant (13). Treating the supernatant (13) with a food grade C₁-C₆ solvent such as ethanol precipitates yet another lupin protein designated protein extract or fraction 2 (PF2) which has particularly good functionality (14) and low microbiological load (less than 1000 TPC). Alternatively, the supernatant (13) may be dried to give PF2. The third protein supernatant (9) may, in a preferable aspect of the processes, be treated with a C₂-C₆ solvent such as ethanol and centrifuged to produce a protein pellet, designated protein fraction 3 (PF3), and a waste stream which contains colour and flavour components, including alkaloids.

In the process there are 2-3 waste streams represented in FIG. 1 as 8, 12, and 15. The alkaloids in the waste streams may be recovered by chromatography, such as HPLC, or other techniques known in the art for alkaloid recovery. Such recovered alkaloids may be used as crop protectants due to their insecticidal properties.

In accordance with the process embodiments of this invention, up to 85% lupin protein yield may be obtained. The lupin protein recovered may contain from about 50% to about 95% lupin protein. Other components in the fraction may include lipophilic material such as fats, minor amounts of carbohydrates and other lupin components. Additional purification steps can be added if desired.

Lupin protein extract (PF1) contains about 68% protein, has an emulsion activity of about 53-55%, an emulsion viscosity of about 1000-2000 cpi, a foam volume expansion of about 100-200% and a foam volume stability of about 0-10%. Other minor components of this protein fraction may include moisture, fat, fibre, small amounts of carbohydrate and ash.

Protein extract (PF2) has a protein content of about 53%, about 100% emulsion activity, an emulsion viscosity of about 3400 cpi, a foam expansion volume of about 600-710% and a foam volume stability of about 97-100%. This extract also includes some fat, fibre, carbohydrate and ash.

The lupin protein recovered according to the process of this invention, such as PF2 and PF3, has a very bland flavour and particularly high functionality with respect to whipping and emulsification (emulsification up to 100% as described in Example 3) and whipping up to 700% (as described in Example 3). These properties make the lupin protein in accordance with this invention particularly suitable as a replacement for dairy, egg and soy proteins in a range of food applications. Examples include, but are not restricted to, baked products, milk replacer, whipped products and toppings, ice cream, soups, pasta and pasta sauces, desserts, ice creams and other dairy products, hot and cold beverages, non dairy whiteners, cream liqueurs, meat based smallgoods, and other food products. PF1, for example, also has good emulsifying properties (65%) and may be used to replace egg, soy and dairy proteins, for example in a wide range of meat and baked products.

According to another aspect of the invention there is provided a food product containing a food grade lupin protein, for example as a replacement for dairy, egg, soy or meat protein. Preferably the lupin protein is selected from one or more of lupin protein extracts PF1, PF2 and/or PF3. The protein fractions have high protein content (about 50 to about 85% or more) and a good amino acid profile making them suitable as a nutritional supplement for paediatric, sports and clinical nutrition, for example in sport drinks, energy bars, as a sprinkled or granulated additive to food or drink, or other such uses.

In accordance with another aspect of the invention, there is provided a nutritional supplement containing a food grade lupin protein. Preferably the food grade lupin protein is selected from lupin protein extracts PF1, PF2 and/or PF3.

Lupin protein also finds use as a binder in the paper industry, in adhesives, glues, and resins for example.

The lupin protein products can also be blended with various additives like polyphosphates or gums, flow control agents, mouth texture agents, and the like. Examples of various prepared food formulations are set out in the examples.

The alkali insoluble lupin fibrous component recovered in the process of this invention may be used in a range of applications. It may be further treated with peroxide or washed in organic solvent, such as a C₁-C₆ solvent, for example ethanol, and centrifuged to produce a cream or off-white fibre. The lupin fibre can be used in a range of food products and animal feeds or further processed using enzymes, such as galactosidases, to produce a galactose rich concentrate for use in sports drinks. This fibre also has industrial application where plant fibres are used, including as a carrier in adhesives, such as corrugating adhesives.

In a further embodiment this invention relates to a lupin fibre component.

The invention will now be further exemplified with reference to the following non-limiting examples.

FIG. 1 shows a process diagram of an embodiment of the process aspect of the invention.

### EXAMPLE 1

500 g of lupin flour is mixed with 2-5 litres of water, stirred in a tank with mild agitation, and the pH raised by addition of sodium hydroxide to a pH between 8 and 10. The mixture is agitated for a period of 30 minutes to 2 hours at ambient temperature (25° C.). The mixture is then centrifuged at 6000 g for 10 minutes to recover a fibre containing pellet.

The fibre containing pellet is washed with 700 ml of water and recentrifuged. The fibrous pellet is then dried and reserved for later processing for recovery of sugars, pectins and other carbohydrate components.

The water wash is added to the first supernatant, and the pH adjusted to between pH 3 to 5 with acid (hydrochloric or phosphoric acid). The resulting acidified composition was centrifuged at 6000 g, and a protein fraction (PF1) recovered. PF1 is adjusted to 5 to 6.5 with alkali, ethanol washed, and dried to remove ethanol, for example by spray drying or rotary evaporation, to give a proteinaceous powder.

The resulting supernatant is adjusted to pH 5 to 7 with potassium hydroxide, causing a flocculated protein isolate to precipitate. This isolate may be recovered by centrifugation for subsequent use in various applications.

The remaining supernatant is treated with 1300 ml of ethanol to produce a protein precipitated fraction PF2.

The protein fraction 1 and protein fraction 2 and isolate were analysed and were found to compose the following:

| | Protein | Protein | |
|---|---|---|---|
| | fraction 1 | fraction 2 | Isolate |
| Protein wt grms | 93 | 19.75 | 22.58 |
| Protein yield % | 55.02 | 11.6 | 13.3 |
| Emulsification activity | 53-55% | 100% | 55-59% |
| Emulsion viscosity | 1000-2000 cpi | 3400 cpi | 2500 cpi |
| Foam volume expansion | 100-200% | 600-710% | 10 |
| Foam volume stability | 0-10% | 97-100% | 0 |
| Protein % | 68.2 | 53.6 | 87.5 |
| Moisture % | 3.4 | 5 | 4.6 |
| Fat % | 16.3 | 1 | 2.9 |
| Total fibre % | 5.6 | 18.2 | 1.2 |
| CHO % | 2 | 6 | 3.7 |
| Ash % | 9.3 | 15.8 | 5.6 |
| Salt % | | | |

### EXAMPLE 2

Application of the lupin protein of Example 1.

| Ingredients | % |
|---|---|
| Maltodextrin | 36 |
| Water | 39.6 |
| Lupin protein extract PF3 | 1.8 |
| Fat | 21 |
| Emulsifier | 0.6 |
| Dipotassium phosphate | 1 |

Procedure:

Premix water protein and dipotassium phosphate and heat to 50C.

Add maltodextrin and heat to 65C.

Add fat and emulsifier and heat to 85C

Emulsify using twin screw homogeniser and spray dry

Continental Frankfurt

| Ingredients | % |
|---|---|
| Mutton (90% lean) | 15 |
| Pork trimmings (50% lean:50% fat) | 36.44 |
| Pork fat | 11 |
| Ice water | 27.3 |
| Potato starch | 4 |
| Lupin protein isolate, or lupin protein extract PF1 | 2.8 |
| Salt | 2 |
| Frankfurt flavour concentrate | 0.3 |
| Smoke flavour | 0.5 |
| Sodium tripolyphosphate | 0.5 |
| Sodium erythorbate | 0.1 |
| Sodium nitrite | 0.02 |
| Sodium metabisulphite | 0.04 |

Procedure

1. Mince chop together approx 30% ice plus lupin protein isolate.

2. Add fat and remaining ice water-chop to form a smooth creamy fat emulsion (approx 60 sec).

3. Add meat, continue chopping (approx 30-60 sec).

4. Add salt, phosphate, sodium nitrite, sodium erythorbate and cut until temp 5C.

5. Add seasoning and chop until temp reaches 10C.

6. Add starch and cut until temp 12C.

7. Fill mixture into casings.

8. Fully immerse frankfurts in 75° C. water cooker and heat to an internal temperature of 72° C.

9. Cool in ice water at 4° C. Cool to internal temperature of 10° C.

10. Chill further in blast chiller.

Meat Product

| Ingredients | % |
|---|---|
| Meat | 66-68 |
| Ice water | 28-30 |
| Salt | 2-3 |
| Lupin protein extract PF1, PF2 or PF3 | 2-3 |
| Phosphates | 0.3-0.5 |
| Sodium nitrite | 0.025 |
| Sodium erythorbate | 0.1 |
| Potato starch | 2.0-4.0 |

Procedure:

1. Dissolve phosphate, sugar, salt and curing agent in water.

2. Add protein isolate prior to use

3. pH should be 6-6.5

4. Section meat as desired

5. Inject brine into meat with multineedle injector

6. Stuff in casing and process

Calcium Fortified protein beverage

| Ingredients | % |
|---|---|
| Water | 88 |
| Lupin protein extract PF2 or PF3 | 4 |
| Canola oil | 2 |
| Sucrose | 2 |
| Maltodextrin 28DE | 3 |
| Tricalcium phosphate | 0.3 |
| Potassium citrate | 0.1 |
| Emulsifier | 0.1 |
| Carrageenan | 0.02 |

Procedure:

1. Mix water and dry ingredients.

2. Heat oil and emulsifier to 60° C.

3. Add water mixture to oil/emulsifier blend and heat to 70° C.

4. Homogenize using Silverson.

### EXAMPLE 3

Performance tests on lupin protein emulsification and foaming.

1. Emulsification Test

1. Take 7 gm of lupin protein.

2. Add 100 mls of water.

3. Mix in the omni mixer at 5000 rpm for 10 seconds.

4. Add 100 mls of canola oil and mix for 1 minute.

5. Measure the viscosity in the Brookfield viscometer with spindle 3 at 5 rpm

6. Take 40 g of the emulsion.

7. Centrifuge at 3000×g for 10 minutes.

8. Measure the height of the emulsified layer (A) and the total height in the tube (B).

9. Emulsifying activity is measured as A/B*100.

2. Whipping test

1. Take 5 gm of sample as is

2. Add 100 mls of water

3. Whip for 5 min in kenwood mixer.

4. Pour the contents in a 1000 ml, clear measuring cylinder.

5. Measure the total height including the foam.

6. Let the foam stand for 30 minutes.

7. Measure the volume of foam alone and the amount of liquid drained at the bottom of the foam.

Foam Volume expansion is calculated as:

$$\frac{Total volume - initial volume}{Initial volume} \times 100.$$

Throughout this specification and the claims which follow, unless the context requires otherwise, the word “comprise”, or variations such as “comprises” or “comprising”, will be understood to imply the inclusion of a stated integer or step or group of integers or steps but not the exclusion of any other integer or step or group of integers or steps.

The reference to any prior art in this specification is not, and should not be taken as an acknowledgment or any form of suggestion that that prior art forms part of the common general knowledge in Australia.

1. A process for the production of lupin protein extracts from lupins, comprising:
(a) extracting lupin meal or flour with water at alkaline pH;
(b) separating an alkali soluble lupin protein containing component from an alkali insoluble fibrous component;
(c) adjusting the pH of the protein component with acid to a pH between 3-5.0, and thereafter separating a food grade lupin protein extract (PF1) from an acid soluble lupin protein containing component; and optionally,
(d) reacting the acid soluble lupin protein containing component with a C1-C6 food grade organic solvent and recovering therefrom a second food grade lupin protein extract (PF3); or
(e) raising the pH of the acid soluble lupin protein component to pH 5-7, and optionally recovering a lupin protein isolate, followed by the addition of a C1-C6 food grade organic solvent and recovering therefrom a third food grade lupin protein fraction (PF2).

2. A process according to claim 1 wherein lupin meal or flour is mixed with water at a ratio of lupin flour or meal to water of 1:2-10 on a w/w basis.

3. A process according to claim 1 wherein said lupin meal or flour is extracted with water at an alkaline pH of from about pH7-pH9.

4. A process according to claim 1, which comprises said process steps (a) through (c), (a) through (d), or (a) to (c) and (e).

5. A process according to claim 1 wherein said food grade organic solvent is selected from ethanol and propanol.

6. A process according to claim 1 wherein one or more lupin protein extracts PF1, PF2 and PF3 are recovered.

7. A process according to claim 1 wherein a lupin protein isolate is recovered.

8. A process according to claim 1 which produces lupin protein extracts and isolate having a light, colour and bland non-bitter taste.

9. A process according to claim 1 for the production of a food grade lupin protein extract.

10. A food product containing a lupin protein extract produced according to the process of claim 1.

11. A food product according to claim 10 wherein said lupin protein is a replacement for dairy, egg, soy or meat protein in the food product.

12. A nutritional supplement containing a lupin protein extract produced according to the process of claim 1.

13. A nutritional supplement according to claim 12 containing lupin protein extract PF1, PF2 or PF3.

14. A paper coating composition containing a lupin protein extract produced according to the process of claim 1.

15. A paper coating, according to claim 14 wherein said lupin protein extract is selected from PF1, PF2 and PF3.

16. A feed ingredient containing a lupin protein extract produced according to the process of claim 1.

17. A feed ingredient according to claim 16 wherein said lupin protein extract is selected from PF1, PF2 and PF3.

18. A food product containing a lupin protein isolate produced according to the process of claim 1.

19. A food product according to claim 18 wherein said lupin protein isolate is a replacement for dairy, egg, soy or meat protein in said food product.

20. A process according to claim 1 wherein said alkali insoluble fibrous component is, recovered.

21. A process according to claim 20 wherein said alkali insoluble fibrous component is washed in water and subsequently treated with one or more enzymes to produce galactose.
